(19) United States
(12) Patent Application Publication
(10) Pub. No.: US 2026/0310365 A1
(43) Pub. Date: Oct. 8, 2026

(54) METHODS AND APPARATUSES FOR OPERATING A MEMORY SYSTEM

(71) Applicant: Yangtze Memory Technologies Co., Ltd., Wuhan (CN)

(72) Inventor: Kui WANG, Wuhan (CN)

(21) Appl. No.: 19/226,878

(22) Filed: Jun. 3, 2025

Related U.S. Application Data
(63) Continuation of application No. PCT/CN2025/086846, filed on Apr. 2, 2025.

(51) Int. Cl. G06F 3/06

(52) U.S. Cl. CPC G06F 3/0634; G06F 3/0604; G06F 3/0659; G06F 3/0679

(57) ABSTRACT

Methods, devices, and systems for managing memory devices are provided. In one aspect, a system includes a host and a memory system coupled to the host. The memory system includes a memory controller and a memory device. The host is configured to, based on an operation mode of the memory system, power up the memory controller and the memory device sequentially or at the same time. The memory controller is configured to determine whether the memory device is powered up, and in response to determining that the memory device is powered up, control the memory system to operate in a first mode among more than one mode.

### CROSS-REFERENCE TO RELATED APPLICATIONS

This application is a continuation of International Application No. PCT/CN2025/086846, filed on Apr. 2, 2025, the disclosure of which is hereby incorporated by reference in its entirety.

### TECHNICAL FIELD

The present disclosure generally relates to memory devices and memory systems, and in particular, to managing operation modes of memory systems.

### BACKGROUND

A memory system can include one or more memory devices and a memory controller that manages the data stored in the one or more memory devices and communicates with a host. The host can send commands, for example, read commands and write commands, to the memory system to control operations of the memory system. The memory system can operate in different operation modes.

### SUMMARY

The present disclosure involves methods, apparatuses, and systems for managing a memory system. One aspect of the present disclosure features a system including a host and a memory system coupled to the host. The memory system includes a memory controller and a memory device. The host is configured to, based on an operation mode of the memory system, power up the memory controller and the memory device sequentially or at the same time. The memory controller is configured to determine whether the memory device is powered up, and in response to determining that the memory device is powered up, control the memory system to operate in a first mode among more than one mode.

In some implementations, the memory controller is configured to, in response to determining that the memory device is not powered up, control the memory system to operate in a second mode among the more than one operation mode.

In some implementations, the memory system in the second mode is configured to download firmware code from the host, and the memory system in the first mode is configured to execute the firmware code.

In some implementations, the determining whether the memory device is powered up is performed based on executing a program in a read-only memory (ROM) of the memory controller.

In some implementations, the determining whether the memory device is powered up is performed based on sending one or more commands to the memory device, and determining whether the memory device responds to the one or more commands.

In some implementations, the host is configured to control a power management chip of the memory system. The power management chip includes a first voltage converter configured to supply power to the memory controller, and a second voltage converter configured to supply power to the memory device.

In some implementations, the host is configured to activate the first voltage converter before or at a same time of activating the second voltage converter.

In some implementations, the host is configured to activate the first voltage converter before activating the second voltage converter by sending a configuration signal to the power management chip, where the configuration signal indicates a time interval between activating the first voltage converter and activating the second voltage converter.

In some implementations, the time interval is greater than or equal to 0.5 second.

In some implementations, the memory system includes general purpose input/output (GPIO) pins that are not connected with the host.

In some implementations, the memory system is a universal flash storage (UFS) memory system.

Another aspect of the present disclosure features a memory system including a memory device that is non-volatile, and a memory controller coupled to the memory device. The memory controller is configured to determine whether the memory device is powered up, and in response to determining that the memory device is powered up, control the memory system to operate in a first mode of more than one operation modes, where the memory system in the first mode is configured to execute firmware code of the memory system.

In some implementations, the memory controller is configured to, in response to determining that the memory device is not powered up, control the memory system to operate in a second mode of the more than one operation modes, where the memory system in the second mode is configured to download firmware code from a host coupled to the memory system.

In some implementations, the memory controller is configured to determine whether the memory device is powered up by sending one or more commands to the memory device, and determining whether the memory device responds to the one or more commands.

In some implementations, the memory system includes a power management chip, The power management chip includes a first voltage converter configured to supply power to the memory controller, and a second voltage converter configured to supply power to the memory device.

In some implementations, the power management chip can be configured to activate the first voltage converter before activating the second voltage converter.

In some implementations, the memory system is a universal flash storage (UFS) memory system, and the memory device is a NAND memory device.

A further aspect of the present disclosure features a method of operating a memory system. The method includes determining whether a memory device of the memory system is powered up; and in response to determining that the memory device is powered up, controlling the memory system to operate in a first mode. The memory system in the first mode is configured to execute firmware code of the memory system.

In some implementations, the method further includes, in response to determining that the memory device is not powered up, controlling the memory system to operate in a second mode of the more than one operation modes. The memory system in the second mode is configured to download firmware code from a host coupled to the memory system.

In some implementations, determining whether the memory device is powered up includes sending one or more commands to the memory device; and determining whether the memory device responds to the one or more commands.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having a memory device, according to some aspects of the present disclosure.

FIGS. 2A-2B illustrate example storage products, according to some aspects of the present disclosure.

FIG. 3 illustrates an example of a schematic diagram of a memory device including peripheral circuits, according to some aspects of the present disclosure.

FIG. 4 illustrates some example peripheral circuits, according to some aspects of the present disclosure.

FIG. 5 illustrates a block diagram of an example system including a host, and a memory system including a memory device and a memory controller, according to some aspects of the present disclosure.

FIG. 6 illustrates an example power management chip, according to some aspects of the present disclosure.

FIG. 7 illustrates an example process of controlling a power-up sequence of a memory system, according to some aspects of the present disclosure.

FIG. 8 illustrates an example process of determining an operation mode of a memory system, according to some aspects of the present disclosure.

FIG. 9 illustrates a flow chart of an example method of operating a memory system, according to some aspects of the present disclosure.

Like reference numbers and designations in the various drawings indicate like elements.

### DETAILED DESCRIPTION

This specification relates to memory devices, memory systems, and methods for managing operation modes of a memory system (e.g., a universal flash storage (UFS) memory system). In some cases, the memory system can operate in more than one operation mode, including a load mode, where the memory system can download firmware code from a host, and a firmware mode, where the memory system can execute the firmware code.

In some cases, the host can control the operation mode that the memory system operates in through hardware connection. For example, general purpose input/output (GPIO) pins of the memory system can be connected with the host, and the host can control the operation mode of the memory system by sending signals through the GPIO pins.

The present disclosure provides techniques to manage operation modes of memory systems, e.g., through software control. In some implementations, a host can control the operation mode of a memory system by controlling the power-up sequence of components (e.g., memory controller and memory device) of the memory system. For example, if the host determines that the host will operate in the firmware code, the host can power up the memory controller and the memory device at the same time. When the memory controller is powered up, the memory controller can determine that the memory device is also powered up, so that the memory controller can control the memory system to operate in the firmware mode. If the host determines that the host will operate in the load mode, the host can power up the memory controller and the memory device of the memory system sequentially (e.g., delaying a pre-set time interval after powering up the memory controller and before powering up the memory device). When the memory controller is powered up, the memory controller can determine that the memory device is not yet powered up, so that the memory controller can control the memory system to operate in the load mode.

The described techniques can achieve one or more technical effects. For example, by controlling the operation mode of the memory system by controlling the power-up sequence of the memory system, hardware connections can be reduced between the host and the memory system, which can reduce the cost of manufacturing the memory system. For another example, managing the operation mode of the memory system through software control can increase the efficiency and stability of the memory system. For example, if the memory system fails to initialize due to non-hardware issues, the described techniques can be applied to re-initialize the memory system. In some implementations, additional or different technical effects can be achieved.

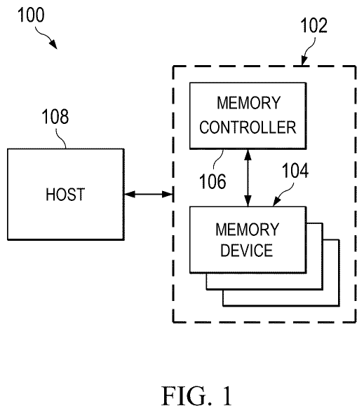

FIG. 1 illustrates a block diagram of an example system 100 having a memory device, according to some aspects of the present disclosure. The system 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, the system 100 can include a host 108 and a memory system 102 having one or more memory devices 104 and a memory controller 106. The host 108 can include one or more processors of an electronic device. The processor can be a central processing unit (CPU), or a system-on-chip (SoC), such as an application processor (AP). The host 108 can be configured to send or receive data and commands to or from the memory systems 102.

The memory device 104 can be any memory device disclosed in the present disclosure, such as a NAND Flash memory device. It is noted that the NAND Flash is only one example of memory device for illustrative purposes. It can include any suitable solid-state, non-volatile memory, e.g., NOR Flash, Ferroelectric RAM (FeRAM), Phase-change memory (PCM), Magne-to-resistive random-access memory (MRAM), Spin-transfer torque magnetic random-access memory (STT-RAM), or Resistive random-access memory (RRAM), etc. In some implementations, memory device 104 includes a three-dimensional (3D) NAND Flash memory device.

The memory controller 106 can be implemented by microprocessors, microcontrollers (a.k.a. microcontroller units (MCUs)), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail.

The memory controller 106 is coupled to the memory device 104 and to the host 108, and is configured to control the memory device 104, according to some implementations. The memory controller 106 can manage the data stored in the memory device 104 and can communicate with the host 108. In some implementations, the memory controller 106 is designed for operating in a low duty-cycle environment, such as secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment solid state drives (SSDs) or embedded multi-media-cards (eMMCs) used as data storage for mobile devices, such as smartphones, tablets, laptop computers, etc., and enterprise storage arrays. The memory controller 106 can be configured to control operations of the memory device 104, such as read, erase, and program operations. The memory controller 106 can also be configured to manage various functions with respect to the data stored or to be stored in the memory device 104 including, but not limited to bad-block management, garbage collection, logical-to-physical address conversion, logical-to-physical mapping management, wear leveling, etc. In some implementations, the memory controller 106 is further configured to process error correction codes (ECCs) with respect to the data read from or written to the memory device 104. Any other suitable functions can be performed by the memory controller 106 as well, for example, formatting the memory device 104.

The memory controller 106 can communicate with an external device (e.g., the host 108) according to a particular communication protocol. For example, the memory controller 106 can communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc. The memory controller 106 is configured to receive and transmit a command to and from the host 108, and execute or perform multiple functions and operations provided in the present disclosure, which will be described later.

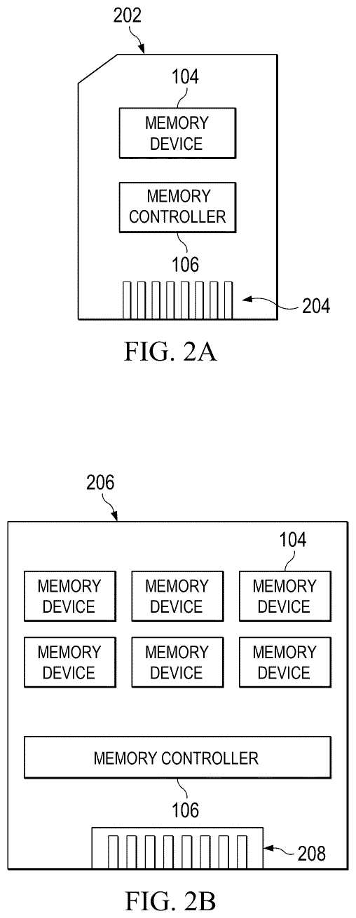

The memory controller 106 and the one or more memory devices 104 can be integrated into various types of storage devices. For example, the memory controller 106 and the one or more memory devices 104 can be packaged in a universal Flash storage (UFS) package or an eMMC package. In one example as shown in FIG. 2A, the memory controller 106 and a single memory device 104 can be integrated into a memory card 202. The memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. The memory card 202 can further include a memory card connector 204 coupling the memory card 202 with a host (e.g., host 108 in FIG. 1). In another example as shown in FIG. 2B, the memory controller 106 and multiple memory devices 104 can be integrated into an SSD 206. The SSD 206 can further include an SSD connector 208 that couples the SSD 206 with a host (e.g., host 108 in FIG. 1). In some implementations, the storage capacity and/or the operation speed of the SSD 206 is greater than those of the memory card 202.

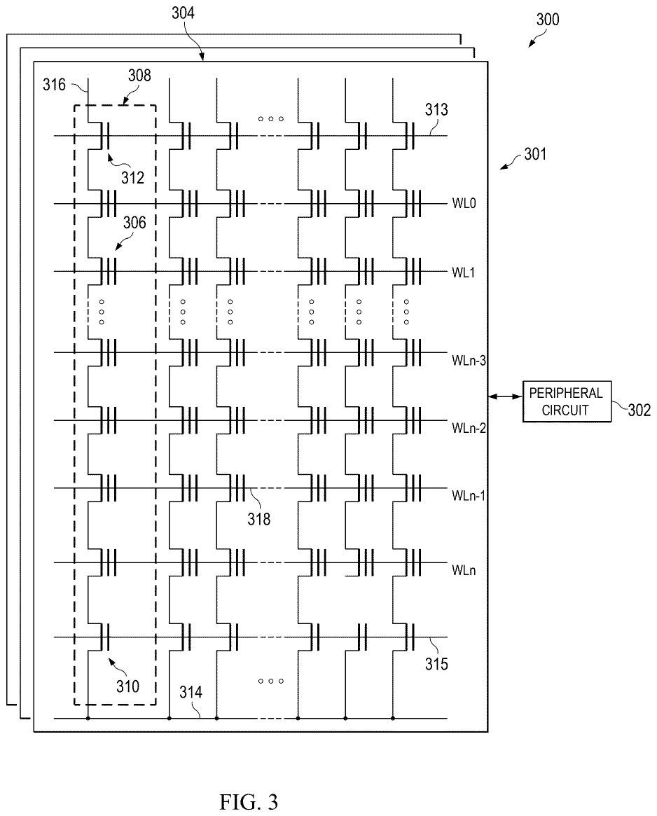

FIG. 3 illustrates an example of a schematic diagram of a memory device 300 including peripheral circuits, according to some aspects of the present disclosure. The memory device 300 can be an example of the memory device 106 of FIGS. 1-2B.

The memory device 300 can include a memory cell array 301 and peripheral circuits 302 coupled to the memory cell array 301. The memory cell array 301 can be a NAND Flash memory cell array in which memory cells 306 are provided in the form of an array of NAND memory strings 308 each extending vertically above a substrate (not shown in FIG. 3). In some implementations, each NAND memory string 308 includes a plurality of memory cells 306 coupled in series and stacked vertically. Each memory cell 306 can hold a continuous, analog value, such as an electrical voltage or charge that depends on the number of electrons trapped within a storage layer of the memory cell 306. The logic state (i.e., data) of each memory cell 306 in a memory block 304 can be determined based on the threshold voltage Vth of the memory cell 306. Each memory cell 306 can be a floating gate type memory cell including a floating-gate transistor, or a charge trap type memory cell including a charge-trap transistor.

In some implementations, each memory cell 306 is a single-level cell (SLC) with two possible memory states that can store one bit of data. For example, the first memory state “0” can correspond to a first range of voltages, and the second memory state “1” can correspond to a second range of voltages. In some implementations, each memory cell 306 is a multi-level cell (MLC) that is capable of storing more than one bit of data in more than two memory states. For example, the MLC can store two bits per cell, three bits per cell (also known as triple-level cell (TLC)), or four bits per cell (also known as a quad-level cell (QLC)). Each MLC can be programmed to support a range of possible nominal storage values. In one example, if each MLC stores two bits of data, then the MLC can be programmed to one of three possible programming levels from an erased state by writing one of three possible nominal storage values to the cell. A fourth nominal storage value can be used for the erased state.

As shown in FIG. 3, each NAND memory string 308 can include a source select gate (SSG) 310 at its source end and a drain select gate (DSG) 312 at its drain end. The SSG 310 and the DSG 312 can be configured to activate selected NAND memory strings 308 (columns of the array) during read and program operations. In some implementations, the sources of NAND memory strings 308 in the same memory block 304 are coupled through a same source line (SL) 314, e.g., a common SL. In other words, NAND memory strings 308 in the same memory block 304 have an array common source (ACS), according to some implementations. The DSG 312 of each NAND memory string 308 is coupled to a respective bit line 316 from which data can be read or written via an output bus (not shown), according to some implementations. In some implementations, each NAND memory string 308 is configured to be selected or deselected by applying a select voltage (e.g., above the threshold voltage of the transistor having the DSG 312) or a deselect voltage (e.g., 0 V) to the respective DSG 312 through one or more DSG lines 313, and/or by applying a select voltage (e.g., above the threshold voltage of the transistor having the SSG 310) or a deselect voltage (e.g., 0 V) to the respective SSG 310 through one or more SSG lines 315.

As shown in FIG. 3, NAND memory strings 308 can be organized into multiple memory blocks 304, each of which can have a common SL 314 coupled to the ACS. In some implementations, each memory block 304 can serve as a basic data unit for erase operations, such that memory cells 306 on the same memory block 304 are erased at the same time. To erase memory cells 306 in a selected memory block 304, the SL 314 coupled to the selected memory block 304 and unselected memory blocks in the same plane can be biased with an erase voltage. For example, the erase voltage can be a high positive voltage (e.g., 20 V or more). In some implementations, an erase operation can be performed at a half-block level, a quarter-block level, or a level having any suitable number of memory blocks or fractions of a memory block.

The memory cells 306 of adjacent NAND memory strings 308 can be coupled through word lines 318. The word line 318 can select which row of memory cells 306 is affected by read and program operations. Each word line 318 can include a gate line coupled to a plurality of control gates (gate electrodes) of a plurality of memory cells 306. Example word lines shown in FIG. 3 include WL0, WL1, WLn-3, WLn-2, WLn-1 and WLn that are between one or more DSG lines 313 and one or more SSG lines 315.

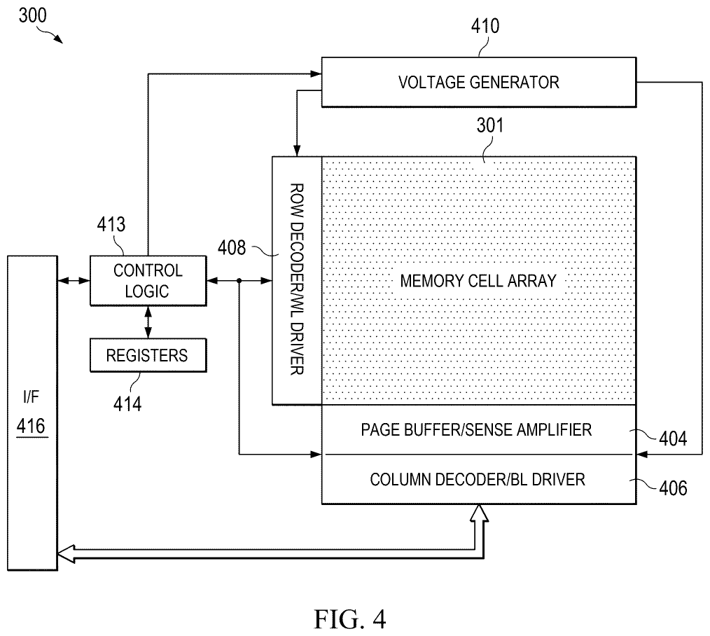

FIG. 4 illustrates some example peripheral circuits 302, according to some aspects of the present disclosure. The peripheral circuits 302 can be coupled to the memory cell array 301 through bit lines 316, word lines 318, SLs 314, SSG lines 315, and DSG lines 313. The peripheral circuits 302 can include any suitable analog, digital, and mixed-signal circuits for facilitating the operations of the memory cell array 301 by applying and sensing voltage signals and/or current signals to and from each target memory cell 306 through bit lines 316, word lines 318, SLs 314, SSG lines 315, and DSG lines 313. The peripheral circuits 302 can include various types of peripheral circuits formed using metal-oxide-semiconductor (MOS) technologies. The example peripheral circuits 302 include a page buffer/sense amplifier 404, a column decoder/bit line driver 406, a row decoder/word line driver 408, a voltage generator 410, control logic 412, registers 414, an interface 416, and a data bus. In some examples, additional peripheral circuits not shown in FIG. 4 may be included as well.

The page buffer/sense amplifier 404 can be configured to read and program (write) data from and to memory cell array 301 according to the control signals from control logic 412. In an example, the page buffer/sense amplifier 404 may store one page of program data (write data) to be programmed into one page of the memory cell array 301. In another example, the page buffer/sense amplifier 404 may perform program verify operations to ensure that the data have been properly programmed into memory cells 306 coupled to selected word lines 418. In still another example, the page buffer/sense amplifier 404 may also sense the low power signals from the bit line 316 that represents a data bit stored in memory cell 306, and amplify the small voltage swing to recognizable logic levels in a read operation. The column decoder/bit line driver 406 can be configured to be controlled by the control logic 412 and select one or more NAND memory strings 308 by applying bit line voltages generated from the voltage generator 410.

The row decoder/word line driver 408 can be configured to be controlled by the control logic 412 and select/deselect memory blocks 304 of the memory cell array 301 and select/deselect word lines 418 of the memory block 304. The row decoder/word line driver 408 can be further configured to drive word lines 418 using word line voltages generated from the voltage generator 410. In some implementations, the row decoder/word line driver 408 can also select/deselect and drive SSG lines 315 and DSG lines 313. As described below in detail, the row decoder/word line driver 408 is configured to apply a program voltage to selected word line 418 in a program operation on memory cell 306 coupled to selected word line 418.

The voltage generator 410 can be configured to be controlled by the control logic 412 and generate the word line voltages (e.g., read voltage, program voltage, pass voltage, local voltage, verify voltage, etc.), bit line voltages, and source line voltages to be supplied to the memory cell array 301.

The control logic 412 can be coupled to each peripheral circuit described above and configured to control operations of each peripheral circuit. The registers 414 can be coupled to the control logic 412 and include status registers, command registers, and address registers for storing status information, command operation codes (OP codes), and command addresses for controlling the operations of each peripheral circuit.

The interface 416 can be coupled to the control logic 412 and act as a control buffer to buffer and relay control commands received from a host (not shown) to the control logic 412 and status information received from the control logic 412 to the host. The interface 416 can also be coupled to the column decoder/bit line driver 406 via a data bus, and act as a data input/output (I/O) interface and a data buffer to buffer and relay data to and from the memory cell array 301.

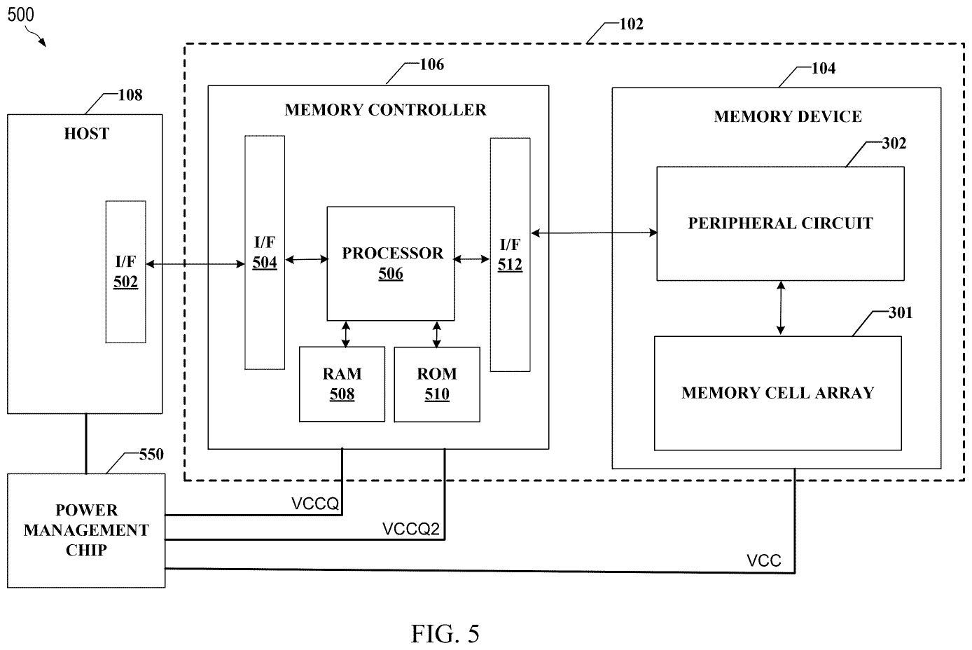

FIG. 5 illustrates a block diagram of an example system 500 including a host 108, and a memory system 102 including a memory device 106 and a memory controller 104, according to some aspects of the present disclosure. The memory device 106 can include a memory cell array (e.g., memory cell array 301 of FIG. 3) and peripheral circuits (e.g., peripheral circuits 302 of FIGS. 3-4) coupled to the memory cell array. In some implementations, the memory device 106 can be a NAND memory device, a NOR memory device, or any suitable non-volatile memory device.

In some implementations, the host 108 can be a processor of an electronic device, such as a central processing unit (CPU), or a system-on-chip (SoC), such as an application processor (AP). The host 108 can be configured to send or receive data to or from the memory system 102. The host 108 can include an interface 502 configured to communicate with the memory system 102.

The memory controller 106 is coupled to the memory device 104, and can manage the data stored in the memory device 104 and communicate with the host 108. The memory controller 106 can include one or more processors 506, a host interface 504, a memory interface 512, a random access memory (RAM) 508, and a read-only memory (ROM) 510.

The processor 506 can be coupled to the RAM 508 and the ROM 510. In some implementations, when the memory system 102 is powered up, firmware codes of the memory system 102 can be read from the memory cell array 301 to the RAM 508, so that the processor 506 can execute the firmware code. The RAM 508 may be a dynamic RAM (DRAM) or a static RAM (SRAM). In some implementations, the RAM 508 can be included in the memory controller 106, or can be coupled to the memory controller 106 as an external device. The RAM 508 can further be configured to store temporary information, e.g., data received from the host 108 before writing the data to the memory device 104, and/or data read from the memory device 104 before sending the data to the host 108. In some implementations, the ROM 510 can store small programs that do not require frequent changes, e.g., boot programs, hardware initialization codes, etc.

In some implementations, the memory system 102 can operate in different operation modes. For example, when the memory system 102 operates in a first mode (e.g., a firmware mode), the memory system 102 can execute the firmware code. For instance, the memory controller 104 can read the firmware code from the memory cell array 301 to the RAM 508, so that the processor 506 can execute the firmware code to control operations of the memory system 102. When the memory system 102 operates in a second mode (e.g., a load mode), the memory system can download firmware code from the host 108, and store the firmware code in the memory cell array 301. In some implementations, the memory system 102 operates in the load mode to download the initial firmware code (e.g., during research and development, or before entering the consumer market), or to download updated firmware code (e.g., during repair or upgrade). In some implementations, the memory system 102 can operate in additional and/or different operation modes.

In some implementations, the host interface can include general purpose input/output (GPIO) pins. In some cases, the GPIO pins can be connected to the host to transmit signals indicating the operation mode of the memory system, e.g., whether the memory system operates in the first mode or the second mode. In some implementations, the host can control the operation mode of the memory system by controlling the power-up sequence of different components of the memory system, as explained in detail below, such that the memory GPIO pins may not be used to indicate the operation mode of the memory system. For example, the GPIO pin may be not connected with the host, or the GPIO pins can be used to transmit other signals.

In some implementations, the memory system 102 can be powered by multiple supply voltages, e.g., VCC, VCCQ, and VCCQ2 as shown in FIG. 5. As an example, VCC (e.g., 2.4V-2.7V, or 2.7V-3.3V) can be the supply voltage that powers the memory device 104, while VCCQ (e.g., 1.14V-1.26V) and VCCQ2 (e.g., 1.70V-1.95V) can be the supple voltages that power the memory controller 106. In some implementations, VCCQ can be used to power the memory controller 106 and optionally for other physical interfaces, and any other internal very low voltage block of the memory system 102. VCCQ2 can be used to power physical interfaces, the memory controller 106, and any other internal low voltage block of the memory system 102.

In some implementations, the host 108 can control the power-up sequence of the supply voltages. For example, the system 500 can include a power management chip 550 (e.g., a power management integrated circuit (PMIC) chip) that includes voltage converters to generate VCC, VCCQ, and VCCQ2, respectively. By sending configuration signals to the power management chip 550, the host can control whether to power up the memory controller 106 and the memory device 104 at the same time, or to power up the memory controller 106 and the memory device 104 sequentially. In some implementations, to power up the memory controller 106 and the memory device 104 at the same time, the power management chip 550 can output VCC and VCCQ, VCCQ2 simultaneously, or within a short duration (e.g., 20 ms, 50 ms, or any other suitable small duration). To power up the memory controller 106 and the memory device 104 sequentially, the power management chip 550 can output VCCQ, VCCQ2 first, and output VCC after a pre-set time interval (e.g., 500 ms, 1 s, or any other suitable duration) after outputting VCCQ and VCCQ2.

In some implementations, the memory system 102 can determine its operation mode based on the power-up sequence. For example, if the memory controller 106 and the memory device 104 are powered up at the same time, the memory system 102 can operate in the first mode (e.g., firmware mode). If the memory controller 106 and the memory controller are powered up sequentially, the memory system 102 can operate in the second mode (e.g., load mode). In some implementations, when the memory controller 106 is powered up, the memory controller 106 can determine whether the memory device 104 is powered up or not. If the memory controller 106 determines that the memory device 104 is powered up during the pre-set time interval, the memory controller can control the memory system 102 to operate in the first mode; if the memory controller 106 determines that the memory device 104 is not powered up during the pre-set time interval, the memory controller can control the memory system 102 to operate in the second mode.

In some implementations, the memory controller 106 can determine whether the memory device 104 is powered up by executing a program in the ROM 510 of the memory controller 106. When executing the program, the memory controller 106 can send one or more commands (e.g., read commands) to the memory device 104, and determine whether the memory device 104 can respond to the command (e.g., by sending back data, or sending a response). If the memory device 104 can respond to the commands, the memory controller 106 can determine that the memory device 104 is powered up. If the memory device 104 does not respond to the commands, the memory controller 106 can determine that the memory device 104 is not yet powered up.

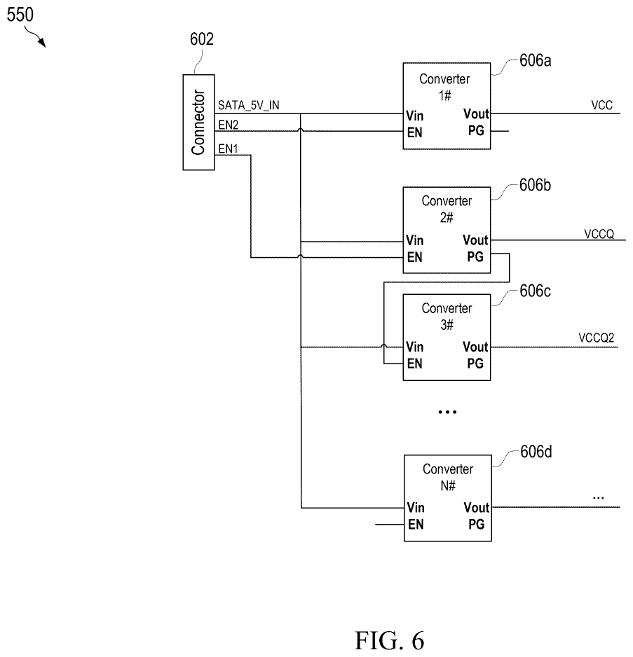

FIG. 6 illustrates an example power management chip 550, according to some aspects of the present disclosure. The power management chip 550 can include a connector 602 and one or more voltage converters 606a, 606b, 606c, 606d (collectively 606).

The connector 602 can be configured to connect the power management chip 550 to a host (e.g., host 108 of FIGS. 1 and 5), for example, to a computer's motherboard, or to a testing platform. In some implementations, the connector 602 is connected to the host according to a particular interface, such as a Serial ATA (SATA) interface. In some implementations, the connector 602 can include a set of pins (e.g., 7 pins) used for data transmission, and a set of pins (e.g., 15 pins) used for power supply. For example, the connector 602 can deliver a power of 5V to the power management chip 550 and transmit enable signals from the host.

A voltage converter 606 can be configured to convert an input voltage (e.g., supply voltage received from the host) to an output voltage that is suited to power a specific component of the memory system 102. Examples of the voltage converter 606 include a low-dropout (LDO) regulator, a buck regulator, or another type of regulator that converts a source of direct current from one voltage level to another. Each voltage converter 606 can include an input pin connected to the supply voltage received from the host, an enable pin configured to activate or deactivate the voltage converter 606, an output pin connected to a voltage line that powers a specific component of the memory system 102, and a status pin (e.g., power good (PG) pin) that indicates that power of the voltage converter is good.

For example, as shown in FIG. 6, voltage converter 606a can be configured to convert the supply voltage of the host to VCC, and provide power for the memory device 104; voltage converter 606b can be configured to convert the supply voltage of the host to VCCQ, and provide power for some components of the memory controller 106; and voltage converter 606c can be configured to convert the supply voltage of the host to VCCQ2, and provide power for other components of the memory controller 106. In some implementations, the power management chip 550 can include additional voltage converters 606d that can provide power for other components/circuits of a system (e.g., the system 500 of FIG. 5).

In some implementations, the voltage converters 606 can be activated by the enable signals. To power up the memory controller and the memory device at the same time, the voltage converter 606a and the voltage converters 606b, 606c can be activated by enable signals at the same time (e.g., simultaneously, or within a small time interval such as 20 ms or 50 ms). To power up the memory controller and the memory device sequentially, the voltage converters 606b, 606c can be activated first by a first enable signal (EN1), and the voltage converter 606a can be activated by a second enable signal (EN2) after a pre-set time interval (e.g., 500 ms, 1 s, or any other suitable duration) after activating the voltage converters 606b, 606c.

In some implementations, the host can send the enable signals to the power management chip 550 to activate the voltage converters 606. In some implementations, the host can send a configuration signal to the power management chip 550. The configuration signal can indicate a time interval between activating the voltage converters 606b, 606c and activating the voltage converter 606a. For example, the host can control voltage levels of general purpose input/output (GPIO) pins that are coupled to the power management chip 550, where each GPIO pin can correspond to an enable signal to a load switch to activate the power supply of one of VCC, VCCQ or VCCQ2. In some implementations, the host can control the sequence of activating VCC, VCCQ and VCCQ2 by adjusting transition timings of GPIO voltage levels. As an example, GPIO pins that control load switches of VCCQ and VCCQ2 can transition from low voltage to high voltage, before a GPIO pin that controls a load switch of VCC transitions from low voltage to high voltage (e.g., with a time interval of 500 ms, 1 s, 2 s, or any suitable time duration). The memory controller can check whether the memory device is powered up or not during the time interval.

In some implementations, the enable pin of the voltage converter 606c is connected to the status pin of the preceding voltage converter 606b. For example, when the power of voltage converter 606b is good, its status pin can output a high voltage. The enable pin of the voltage converter 606c can receive the high voltage, which indicates activating the voltage converter 606c. As such, the voltage converters that are connected in series (e.g., voltage converters 606b and 606c) can be activated simultaneously or within a short duration.

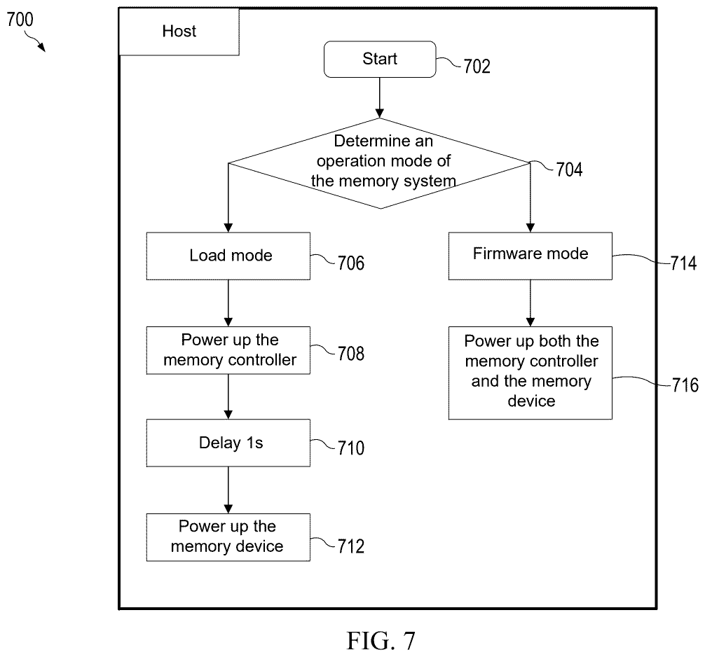

FIG. 7 illustrates an example process 700 of controlling a power-up sequence of a memory system (e.g., the memory system 102 of FIGS. 1 and 5), according to some aspects of the present disclosure. The process 700 can be performed by a host (e.g., host 108 of FIGS. 1 and 5). The operations shown in process 700 may not be exhaustive and other operations can be performed as well before, after, or in between any of the illustrated operations. Further, some of the operations may be performed simultaneously, or in a different order than shown in FIG. 7.

Process 700 starts at 702. For example, at 702, the memory system is coupled to the host.

At 704, the host determines an operation mode of the memory system. In some implementations, the memory system can operate in more than one operation mode, including a first mode (e.g., a firmware mode, where the memory system can execute firmware code) and a second mode (e.g., a load mode, where the memory system can download firmware code from the host). If the host determines that the memory system operates in the load mode, the process proceeds to 706 and then to 708, where the host can power up the memory controller and the memory device sequentially. If the host determines that the memory system operates in the firmware mode, the process proceeds to 714 and then to 716, where the host can power up the memory controller and the memory device at the same time.

At 708, the host powers up the memory controller of the memory system. In some implementations, the host can activate one or more voltage converter (e.g., voltage converter 706b, 706c of FIG. 7) of a power management chip that supplies voltage to the memory controller, where output of the one or more voltage converters is VCCQ and/or VCCQ2.

At 710, the host delays a pre-set time interval (e.g., 0.5 s, 1 s, or any other suitable duration) before powering up the memory device.

At 712, the host powers up the memory device of the memory system. In some implementations, the host can activate a voltage converter (e.g., voltage converter 706a of FIG. 7) of the power management chip that supplies voltage to the memory device, where output of the voltage converter is VCC.

At 716, the host powers up the memory controller and the memory device at the same time. In some implementations, the host can activate the voltage converters (e.g., voltage converter 706a, 706b, 706c of FIG. 7) that supply power to both the memory controller and the memory device at the same time.

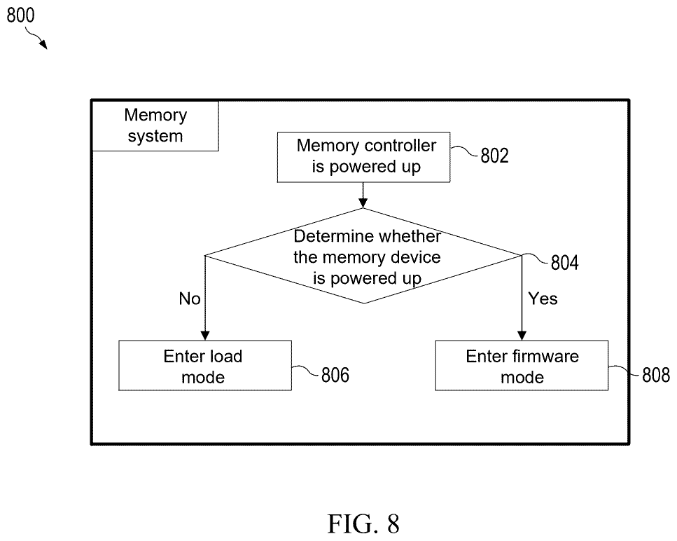

FIG. 8 illustrates an example process 800 of determining an operation mode of a memory system (e.g., the memory system 102 of FIGS. 1 and 5), according to some aspects of the present disclosure. The process 800 can be performed by the memory system, or by a memory controller (e.g., the memory controller 106 of FIGS. 1-2B, 5) of the memory system. The operations shown in process 800 may not be exhaustive and other operations can be performed as well before, after, or in between any of the illustrated operations. Further, some of the operations may be performed simultaneously, or in a different order than shown in FIG. 8.

At 802, the memory controller is powered up. For example, voltage converter(s) that supplies power (e.g., VCCQ, VCCQ2) to the memory controller is activated.

At 804, the memory controller determines whether the memory device is powered up. In some implementations, the memory controller can determine whether the memory device is powered up by sending commands to the memory device and determining if the memory device can respond to the commands. In some implementations, the memory controller determines whether the memory device is powered up during the pre-set time interval between powering up the memory controller and powering up the memory device.

At 806, if the memory device is powered up (e.g., during the pre-set time interval), indicating that the host powers up the memory controller and the memory device at the same time, the memory controller can control the memory system to operate in the first mode (e.g., firmware mode).

At 808, if the memory device is not powered up (e.g., during the pre-set time interval), indicating that the host powers up the memory controller and the memory device sequentially, the memory controller can control the memory system to operation in the second mode (e.g., load mode).

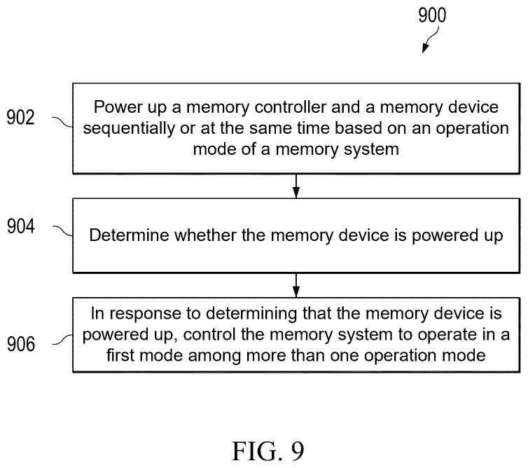

FIG. 9 illustrates a flow chart of an example method 900 of operating a memory system, according to some aspects of the present disclosure. Method 900 can be performed by any suitable device or system as described herein, for example, according to the example techniques described with respect to FIGS. 1-8. For example, method 900 can be performed by a memory system, such as the memory system 102 of FIGS. 1 and 5.

The operations shown in method 900 may not be exhaustive and other operations can be performed as well before, after, or in between any of the illustrated operations. Further, some of the operations may be performed simultaneously, or in a different order than shown in FIG. 9. In some implementations, some of the operations may be performed by one or more components of a device or a system, such as a host (e.g., host 108 of FIGS. 1 and 5) or a memory controller (e.g., memory controller 106 of FIGS. 1-2B and 5).

At 902, the host powers up a memory controller and a memory device sequentially or at the same time, based on an operation mode of a memory system. In some implementations, if the host determines that the memory system will operate in the first mode (e.g., firmware mode), the host can power up the memory controller and the memory device at the same time; if the host determines that the memory system will operate in the second mode (e.g., load mode), the host can power up the memory controller and the memory device sequentially (e.g., delaying a pre-set time interval after powering up the memory controller and powering up the memory device).

At 904, the memory controller determines whether the memory device is powered up. In some implementations, the memory controller determines whether the memory device is powered up during the pre-set time interval.

At 906, in response to determining that the memory device is powered up, the memory controller controls the memory system to operate in the first mode among more than one operation mode. In some implementations, in response to determining that the memory device is not powered up, the memory controller controls the memory system to operate in the second mode among the more than one operation mode.

The present disclosure also provides a non-transitory computer-readable storage medium. The non-transitory computer-readable storage medium stores one or more instructions (e.g., firmware code of a memory system) that are executable by a processor of a memory controller and/or a peripheral circuit of a memory device. When being executed by the processor of the memory controller and/or the peripheral circuit of the memory device, the instructions in the storage medium can implement method for managing operation modes of memory systems, as shown in FIGS. 1-9.

The non-transitory computer-readable storage medium can be an internal storage unit of the device described in any of the foregoing embodiments. For example, the non-transitory computer-readable storage medium can be a hard disk or an internal memory of the device. The non-transitory computer-readable storage medium can also be an external storage device of the device, such as a plug-in hard disk, a smart media card (SMC), a secure digital (SD) card, a flash card, etc. Further, the non-transitory computer-readable storage medium can also include an internal storage unit and an external storage device. In some implementations, the firmware code of the memory system can be stored in a storage medium (e.g., a DRAM coupled to the memory controller) of the memory controller, or in a memory array (e.g., a NAND memory array) of the memory device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting, information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A system, comprising:
a host; and
a memory system coupled to the host, wherein the memory system comprises a memory controller and a memory device,
wherein the host is configured to, based on an operation mode of the memory system, power up the memory controller and the memory device sequentially or at the same time, and
wherein the memory controller is configured to:
determine whether the memory device is powered up; and
in response to determining that the memory device is powered up, control the memory system to operate in a first mode among more than one operation mode.

2. The system of claim 1, wherein the memory controller is configured to:
in response to determining that the memory device is not powered up, control the memory system to operate in a second mode among the more than one operation mode.

3. The system of claim 2, wherein the memory system in the second mode is configured to download firmware code from the host, and
wherein the memory system in the first mode is configured to execute the firmware code.

4. The system of claim 1, wherein the determining whether the memory device is powered up is performed based on executing a program in a read-only memory (ROM) of the memory controller.

5. The system of claim 1, wherein the determining whether the memory device is powered up is performed based on:
sending one or more commands to the memory device; and
determining whether the memory device responds to the one or more commands.

6. The system of claim 1, wherein the host is configured to control a power management chip of the system, wherein the power management chip comprises:
a first voltage converter configured to supply power to the memory controller; and
a second voltage converter configured to supply power to the memory device.

7. The system of claim 6, wherein the host is configured to:
activate the first voltage converter before or at a same time of activating the second voltage converter.

8. The system of claim 7, wherein the host is configured to activate the first voltage converter before activating the second voltage converter by:
sending a configuration signal to the power management chip, wherein the configuration signal indicates a time interval between activating the first voltage converter and activating the second voltage converter.

9. The system of claim 8, wherein the time interval is greater than or equal to 0.5 second.

10. The system of claim 1, wherein the memory system comprises general purpose input/output (GPIO) pins that are not connected with the host.

11. The system of claim 1, wherein the memory system is a universal flash storage (UFS) memory system.

12. A memory system, comprising:
a memory device that is non-volatile; and
a memory controller coupled to the memory device, wherein the memory controller is configured to:
determine whether the memory device is powered up; and
in response to determining that the memory device is powered up, control the memory system to operate in a first mode of more than one operation modes, wherein the memory system in the first mode is configured to execute firmware code of the memory system.

13. The memory system of claim 12, wherein the memory controller is configured to:
in response to determining that the memory device is not powered up, control the memory system to operate in a second mode of the more than one operation mode, wherein the memory system in the second mode is configured to download firmware code from a host coupled to the memory system.

14. The memory system of claim 13, wherein the memory controller is configured to determine whether the memory device is powered up by:
sending one or more commands to the memory device; and
determining whether the memory device responds to the one or more commands.

15. The memory system of claim 13, wherein the memory system comprises a power management chip, wherein the power management chip comprises:
a first voltage converter configured to supply power to the memory controller; and
a second voltage converter configured to supply power to the memory device.

16. The memory system of claim 15, wherein the power management chip can be configured to activate the first voltage converter before activating the second voltage converter.

17. The memory system of claim 13, wherein the memory system is a universal flash storage (UFS) memory system, and wherein the memory device is a NAND memory device.

18. A method of operating a memory system, the method comprising:
determining whether a memory device of the memory system is powered up; and
in response to determining that the memory device is powered up, controlling the memory system to operate in a first mode, wherein the memory system in the first mode is configured to execute firmware code of the memory system.

19. The method of claim 18, comprising:
in response to determining that the memory device is not powered up, controlling the memory system to operate in a second mode of the more than one operation modes, wherein the memory system in the second mode is configured to download firmware code from a host coupled to the memory system.

20. The method of claim 18, wherein determining whether the memory device is powered up comprises:
sending one or more commands to the memory device; and
determining whether the memory device responds to the one or more commands.
